(19) United States
(12) Patent Application Publication
(10) Pub. No.: US 2015/0189328 A1
(43) Pub. Date: Jul. 2, 2015

(54) SYSTEMS AND METHODS FOR TRANSMITTING AND RECEIVING AUDIO AND VIDEO DATA

(71) Applicant: OPHIR EDLIS, Modiin (IL)

(72) Inventor: OPHIR EDLIS, Modiin (IL)

(21) Appl. No.: 14/142,793

(22) Filed: Dec. 28, 2013

(51) Int. Cl. H04N 19/85; H04L 29/06

(52) U.S. Cl. CPC H04N 19/85; H04L 65/601

(57) ABSTRACT

Systems and methods are provided for transmitting and receiving audio and video data. A method may include receiving, one or more audio packets and one or more video packets and determining that a first audio packet is to be transmitted before a first video packet. Furthermore, the method may include determining, based at least in part on a packet size associated with the first audio packet, a first amount of time to delay decoding of the one or more video packets. The method may further include merging the one or more audio packets and the one or more video packets into a single data stream to be transmitted to a receiving device. The method may also include transmitting, to the receiving device as part of the single data stream, the first audio packet and the first video packet.

### TECHNICAL FIELD

The present disclosure generally relates to wireless communication, and in particular, to transmitting and receiving audio data and video data.

### BACKGROUND

Separate data streams audio data and video data may typically be used for transmitting the audio data and the video data between devices. In certain cases, wireless transmission may dictate that a single stream be used to transmit audio data and video data. To this end, transmitting audio data and video in a single data stream may have certain implications for decoding buffers in the receiving device.

### BRIEF DESCRIPTION OF THE DRAWINGS

Reference will now be made to the accompanying figures and diagrams, which are not necessarily drawn to scale, and wherein:

FIG. 1 shows a block diagram of a system for transmitting audio data and video data, according to one or more example embodiments.

FIG. 2 shows a flow diagram for transmitting audio data and video data, according to one or more example embodiments.

FIG. 3 show a flow diagram for transmitting audio data and video data, according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “mobile device” and/or “device” refers, in general, to a wireless communication device, and more particularly to one or more of the following: a portable electronic device, a telephone (e.g., cellular phone, smart phone), a computer (e.g., laptop computer, tablet computer), a portable media player, a personal digital assistant (PDA), or any other electronic device having a networked capability.

As used herein, unless otherwise specified, the term “server” may refer to any computing device having a networked connectivity and configured to provide one or more dedicated services to clients, such as a mobile device. The services may include storage of data or any kind of data processing. One example of the server may include a web server hosting one or more web pages. Some examples of web pages may include social networking web pages. Another example of a server may be a cloud server that hosts web services for one or more computer devices.

As used herein, unless otherwise specified, the term “receiver” may refer to any device or component capable of receiving data, signals, information, etc. For example, a receiver may include an antenna or any other receiving device.

As used herein, unless otherwise specified, the term “transmitter” may refer to any device or component capable of transmitting data, signals, information, etc. For example, a transmitter may also include an antenna or any other transmission device.

As used herein, unless otherwise specified, the term “transceiver” may refer to any device or component capable of performing the functions of a receiver and/or a transmitter.

According to certain embodiments, the functionality provided by the receiver and the transmitter may be included in a single transceiver device.

The present disclosure relates to computer-implemented systems and methods for transmitting and receiving audio and video data. According to one or more embodiments of the disclosure, a device is provided. The device may include a radio transceiver, at least one processor, and an encoder in communication with the radio transceiver and the at least one processor. The encoder may be configured to receive one or more audio packets and one or more video packets. Furthermore, the encoder may be configured to determine that a first audio packet of the one or more audio packets is to be transmitted before a first video packet of the one or more video packets. The encoder may also be configured to determine, based at least in part on a packet size associated with the first audio packet, a first amount of time to delay decoding of the one or more video packets. Additionally, the encoder may be configured to merge the one or more audio packets and the one or more video packets into a single data stream to be transmitted to a receiving device. The encoder may also be configured to and transmit, by the radio transceiver to the receiving device as part of the single data stream, the first audio packet and the first video packet, wherein the first audio packet is transmitted before the first video packet

According to one or more embodiments of the disclosure, a method is provided. The method may include receiving, by a computer comprising one or more processors, one or more audio packets and one or more video packets. The method may also include determining that a first audio packet of the one or more audio packets is to be transmitted before a first video packet of the one or more video packets. Furthermore, the method may include determining, based at least in part on a packet size associated with the first audio packet, a first amount of time to delay decoding of the one or more video packets. The method may further include merging the one or more audio packets and the one or more video packets into a single data stream to be transmitted to a receiving device. The method may also include transmitting, to the receiving device as part of the single data stream, the first audio packet and the first video packet, wherein the first audio packet is transmitted before the first video packet.

According to one or more embodiments of the disclosure, a non-transitory computer-readable medium is provided. The non-transitory computer-readable medium may have embodied thereon instructions executable by one or more processors. The instructions may cause the one or more processors to receive one or more audio packets and one or more video packets and determine that a first audio packet of the one or more audio packets is to be transmitted before a first video packet of the one or more video packets. Additionally, the computer-readable medium may include instructions to determine, based at least in part on a packet size associated with the first audio packet, a first amount of time to delay decoding of the one or more video packets. Moreover, the computer-readable medium may include instructions to r merge the one or more audio packets and the one or more video packets into a single data stream to be transmitted to a receiving device. The computer-readable medium may also include instructions to transmit, by the radio transceiver to the receiving device as part of the single data stream, the first audio packet and the first video packet, wherein the first audio packet is transmitted before the first video packet.

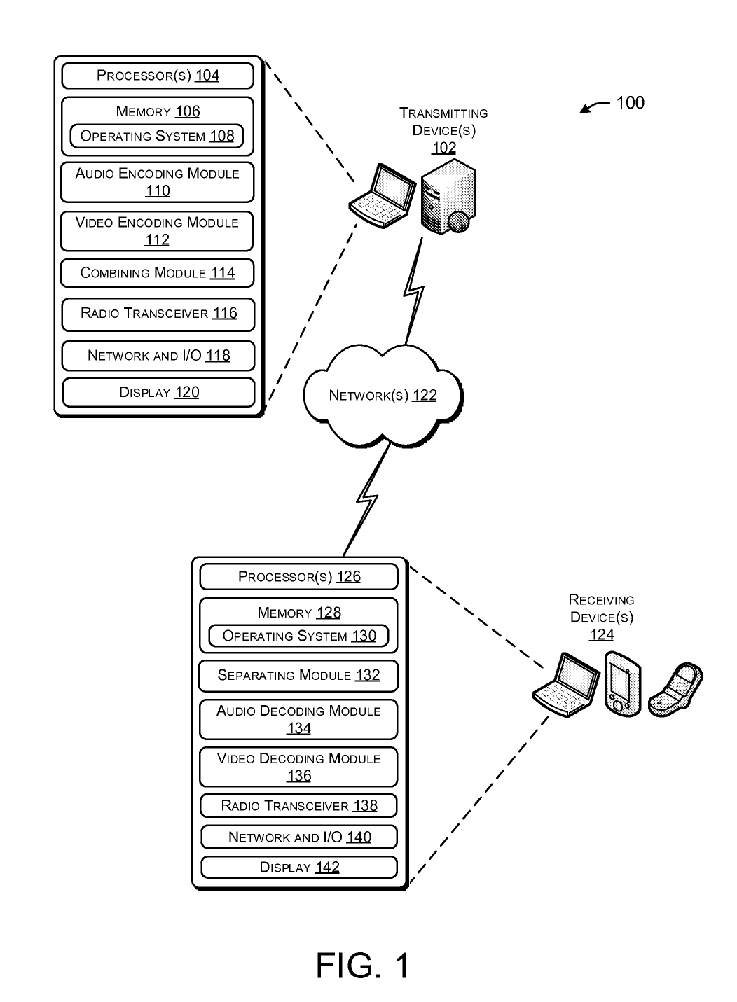

The above principles, as well as perhaps others, are now illustrated with reference to FIG. 1, which depicts a system 100 for transmitting audio and video data. The system 100 may include a transmitting device 102 having one or more computer processors 104 and a memory 106, which may store an operating system 108. The transmitting device 102 may further include an audio encoding module 110, a video encoding module 112, a combining module 114, a radio transceiver 116, network and input/output (I/O) interfaces 118, and a display 120 in communication with each other. The system 100 may also include a network 122 to facilitate communication between the transmitting device 102 and one or more receiving device(s) 124. The receiving device 124 may include one or more computer processors 126, and a memory 128, which may include an operating system 130. The receiving device 124 may further include a separating module 132, an audio decoding module 134, a video decoding module 136, a radio transceiver 138, network and input/output (I/O) interfaces 140, and a display 142 in communication with each other. It will be appreciated that all radio transceivers 116/138 described with respect to the transmitting device 102 and receiving device(s) 124 may be configured to receive and/or transmit any type of radio signals (e.g., WiFi radio signals, Bluetooth radio signals, Bluetooth Low-Energy radio signals, etc.).

The computer processors 104/126 may comprise one or more cores and may be configured to access and execute (at least in part) computer-readable instructions stored in the memory 106/128. The one or more computer processors 104/126 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The transmitting devices 102 may also include a chipset (not shown) for controlling communications between the one or more processors 104/126 and one or more of the other components of the transmitting device 102. In certain embodiments, the transmitting device 102 may be based on an Intel® architecture or an ARM® architecture, and the processor(s) and chipset may be from a family of Intel® processors and chipsets. The one or more processors 104 may also include one or more application-specific integrated circuits (ASICs) or application-specific standard products (ASSPs) for handling specific data processing functions or tasks.

The memory 106/128 may comprise one or more computer-readable storage media (CRSM). In some embodiments, the memory 106/128 may include non-transitory media such as random access memory (RAM), flash RAM, magnetic media, optical media, solid-state media, and so forth. The memory 106 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 106/128 may store an operating system that includes a plurality of computer-executable instructions that may be implemented by the computer processor 104/126 to perform a variety of tasks to operate the interface(s) and any other hardware installed on the transmitting device 102. The memory 106/128 may also store content that may be displayed by the transmitting device 102 or transferred to other devices (e.g., headphones) to be displayed or played by the other devices. The memory 106/128 may also store content received from the other devices. The content from the other devices may be displayed, played, or used by the transmitting device 102 to perform any necessary tasks or operations that may be implemented by the computer processor 104/126 or other components in the transmitting device 102 and/or receiving device 124.

The network and I/O interfaces 118/140 may comprise one or more communication interfaces or network interface devices to provide for the transfer of data between the transmitting device 102 and another device (e.g., network server) via a network (not shown). The communication interfaces may include, but are not limited to: body area networks (BANs), personal area networks (PANs), wired local area networks (LANs), wireless local area networks (WLANs), wireless wide area networks (WWANs), and so forth. The transmitting device 102 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2012, published Mar. 29, 2012;), the Bluetooth standard, the Bluetooth Low-Energy standard, the Wi-Gig standard, and/or any other wireless standard and/or a combination thereof. The wireless system may include a transmitter and a receiver or a transceiver capable of operating in a broad range of operating frequencies governed by the IEEE 802.11 wireless standards. The communication interfaces may utilize acoustic, radio frequency, optical, or other signals to exchange data between the transmitting device 102 and another device such as an access point, a host computer, a server, a router, a reader device, and the like. The network 122 may include, but is not limited to: the Internet, a private network, a virtual private network, a wireless wide area network, a local area network, a metropolitan area network, a telephone network, and so forth.

The display 120/142 may include, but is not limited to, a liquid crystal display, a light-emitting diode display, or an E-Ink™ display as made by E Ink Corp. of Cambridge, Mass. The display may be used to show content to a user in the form of text, images, or video. In certain instances, the display may also operate as a touch screen display that may enable the user to initiate commands or operations by touching the screen using certain finger or hand gestures.

With respect to the transmitting device 102, audio encoding module 110 may include various logic, circuitry, and/or any other type of hardware components to facilitate the encoding of audio data. In certain implementations, the audio encoding module 110 may be a dedicated hardware device (e.g., a hardware accelerator) that may process/encode audio data independently from and/or concurrently with the processors 104. In other implementations, the audio encoding module 110 may be included as part of a separate processing unit, such as a graphics processing unit (GPU). In yet other implementations, the audio encoding module 110 may be a software application stored in memory 106.

The video encoding module 112 may include various logic, circuitry, and/or any other type of hardware components to facilitate the encoding of video data. In certain implementations, the video encoding module 112 may be a dedicated hardware device (e.g., a hardware accelerator) that may process/encode video data independently from and/or concurrently with the processors 104. In other implementations, the video encoding module 112 may be included as part of a separate processing unit, such as a graphics processing unit (GPU). In yet other implementations, the video encoding module 112 may be a software application stored in memory 106.

The combining module 114 may include various logic, circuitry, and/or any other type of hardware components to facilitate combining encoded audio data and encoded video data (e.g., from the audio encoding module 110 and the video encoding module 112, respectively) into a single and/or the same stream of data. Thus, the data stream generated by the combining module 114 may include a mix of both audio packet and video packets. In certain implementations, the combining module 114 may be a dedicated hardware device (e.g., a hardware accelerator) that may process/encode video data independently from and/or concurrently with the processors 104. In other implementations, the combining module 114 may be included as part of a separate processing unit, such as a graphics processing unit (GPU). In yet other implementations, the combining module 114 may be a software application stored in memory 106.

It will be appreciated that while the audio encoding module 110, the video encoding module 112, and the combining module 114 are depicted as separate components, one or more of the modules may be included as part of a single device and/or a single encoder. For example, a hardware accelerator may be configured to perform all the functions of the audio encoding module 110, the video encoding module 112, and the combining module 114.

With respect to the receiving device 124, the separating module 132 may include various logic, circuitry, and/or any other type of hardware components to facilitate the separation and/or deconstruction of the data stream, produced by the combining module 114, into audio packets and video packets. The separating module 132 may provide the audio packets to the audio decoding module 132 and the video packets to the video decoding module 134. In certain implementations, the separating module 132 may be a dedicated hardware device (e.g., a hardware accelerator) that may process/encode video data independently from and/or concurrently with the processors 126. In other implementations, the separating module 132 may be included as part of a separate processing unit, such as a graphics processing unit (GPU). In yet other implementations, the separating module 132 may be a software application stored in memory 128.

The audio decoding module 134 may include various logic, circuitry, and/or any other type of hardware components to facilitate the decoding of audio data, such as the audio packets received from the separating module 132. In certain implementations, the audio decoding module 134 may be a dedicated hardware device (e.g., a hardware accelerator) that may process/encode audio data independently from and/or concurrently with the processors 126. In other implementations, the audio decoding module 134 may be included as part of a separate processing unit, such as a graphics processing unit (GPU). In yet other implementations, the audio decoding module 134 may be a software application stored in memory 128.

The video decoding module 136 may include various logic, circuitry, and/or any other type of hardware components to facilitate the decoding of video data, such as the video packets received from the separating module 132. In certain implementations, the video decoding module 136 may be a dedicated hardware device (e.g., a hardware accelerator) that may process/encode video data independently from and/or concurrently with the processors 126. In other implementations, the video decoding module 136 may be included as part of a separate processing unit, such as a graphics processing unit (GPU). In yet other implementations, the video decoding module 136 may be a software application stored in memory 128.

It will be appreciated that while the separating module 132, audio decoding module 134, and the video decoding module 136 are depicted as separate components, one or more of the modules may be included as part of a single device and/or a single decoder. For example, a hardware accelerator may be configured to perform all the functions of the separating module 132, audio decoding module 134, and the video decoding module 136.

Broadly, a transmitting device 102 may wish to transmit audio data and video data to a receiving device 124. According to certain embodiments, the audio data and the video data may be separately encoded according to a particular encoding standard. However, both the audio data and the video data may be transmitted as part of a single data stream. As such, one or more audio packets and/or one or more video data packets may be mixed, interleaved, and/or otherwise merged in the data stream.

For example, the audio encoding module 110 may be configured to transmit, generate, and/or otherwise provide for one or more audio packets. Similarly, the video encoding module 112 may be configured to transmit, generate, and/or otherwise provide for one or more video packets. In certain implementations, the audio packets and the video packets may be encoded to be stream target decoder (STD) compliant. Furthermore, the audio packets and the video packets may be provided to the combining module 114 in order to merge the audio packets and the video packets into a single data stream. The data stream may be compliant with certain wireless standards. For example, the data stream may be compliant with the wireless display extension (WDE) standard, which may be a Wi-Gig protocol adaption layer. However, it will be appreciated that the audio encoding module 110 and the video encoding module 112 may be configured to encode respective audio packets and video packets according to any other audio and/or video encoding standard. Similarly, it will be appreciated that the data stream may be transmitted and/or compliant with any other standards for transmitting wireless data, such as Wi-Fi, Wi-Fi Direct, Long-Term Evolution (LTE), LTE-Advanced, Bluetooth, Bluetooth Low-Energy, radio frequency identification (RFID), and/or the like.

According to one or more embodiments, the combining module 114 may be configured to determine an order to transmit the audio packets and the video packets. For example, each audio packet may be associated with respective clock values that indicate respective times at which the audio packets were generated. Similarly, each video packet may also be associated with respective clock values that indicate respective times at which the video packets were generated. In certain implementations, these clock values may be referred to as program clock reference (PCR) values and may be appended to the audio packets and the video packets by the audio encoding module 110 and the video encoding module 112, respectively.

The combining module 114 may be configured to determine an order to transmit audio packets and video packets based at least in part on their respective clock values. In some embodiments, the combining module 114 may transmit audio packets and video packets on a first generated first served basis. In other words, a data packet associated with a lower clock value may be transmitted before another data packet that is associated with a higher clock value. For example, a first audio packet and a first video packet may be scheduled for transmission at a particular point in time. The combining module 114 may determine that the first audio packet is associated with a clock value that is less than a clock value associated with the first video packet. As a result, the combining module 114 may determine that the first audio packet should be transmitted before the first video packet. Furthermore, both the first audio packet and the first video packet may be transmitted in a single data stream, with the first audio packet being transmitted before the first video packet.

The data stream may be received by a separating module 132 included in the receiving device 124. To this end, the separating module 132 may be configured to separate the data stream into audio packets and video packets. The separating module 132 may provide the audio packets to the audio decoding module 134 and may provide the video packets to the video decoding module 136. Furthermore, the audio decoding module 134 may be associated with an audio buffer to temporarily store received audio packets from the separating module 132. Similarly, the video decoding module 136 may be associated with a video buffer to temporarily store received video packets from the separating module 132.

As such, the audio decoding module 134 and the video decoding module 136 may be configured to periodically access the audio buffer and video buffer, respectively, to decode respective audio packets and video packets. For example, one or more of the audio packets and the video packets in the data stream may be associated with presentation time values (e.g., the presentation time values may have been appended to audio packets and the video packets by the audio encoding module 110 and the video encoding module 112, respectively). The presentation time values may be a function of and/or may be otherwise based on the respective clock values of the audio packets and video packets. To this end, the audio decoding module 134 may determine when to decode a particular audio packet based at least in part on its associated presentation time value. Similarly, the video decoding module 134 may determine when to decode a particular video packet based at least in part on its associated presentation time value. Furthermore, decoding of a particular audio packet and/or particular video packet may result in that particular audio packet or video packet being evacuated and/or otherwise removed from the respective audio buffer or video buffer (e.g., by the audio decoding module 134 and the video decoding module 136, respectively).

Continuing with the above example, since the first audio packet was transmitted in the data stream before the first video packet, the first audio packet may be provided to the audio decoding module 134 before the first video packet is provided to the video decoding module 136. Thus, the video packet's arrival at the video buffer may be delayed by an amount of time taken to transmit and/or otherwise provide the audio packet to the audio buffer. As a result, a buffer underflow in the video buffer may occur if no other video packets are present in the video buffer. For example, assuming no buffer underflow protection is provided, at a certain point in time T, the separating module 132 may be transmitting and/or otherwise providing the first audio packet to the audio decoding module 134. Also during time T, the video decoding module 136 may be configured to access the video buffer to decode the next video packet, which may be the first video packet. However, the first video packet may not yet be stored in the video buffer (e.g., the first video packet may not yet have been separated from the data stream by the separating module 132). Thus, the video buffer may be empty as the video decoding module 136 attempts to retrieve the first video packet, thereby causing a buffer underflow.

Therefore, in order prevent a buffer underflow, the video encoding module 114 may determine an amount of time by which to delay the video decoding module's 136 access of the video buffer. In certain embodiments, the determination regarding the amount of time to be delayed may be based at least in part on a packet size and/or a compression rate (e.g., bit rate) associated with the first audio packet. For instance, the determination may be based on an actual packet size of the audio packet, or alternatively, the determination may be based on a maximum allowed packet size of audio packets according to a particular encoding standard. For example, under the STD standard, a maximum allowed packet size and a standard bit rate may be associated with all audio packets. To this end, video encoding module 112 may be configured to determine the delayed amount of time to be approximately equal to the maximum allowed packet size of audio packets divided by the standard bit rate of audio packets (e.g., the amount of time used to transmit an audio packet of the maximum allowed audio packet size). Furthermore, the video encoding module 112 may add the delayed amount of time to the presentation time value associated with first video packet (e.g., and/or all subsequently transmitted video packets). Thus, the video decoding module's 136 decoding of the first video packet may be performed at the new presentation time value (e.g., the original presentation time value plus the delayed amount of time), and buffer underflow may be avoided. Regardless of the basis for its determination, the delayed amount of time may be determined such that the first video packet is present in the video buffer when the video decoding module 136 attempts to access the video buffer and/or evacuate the first video packet from the video buffer.

However, as a result of delaying the video decoding module's 136 access of the video buffer, a buffer overflow may occur in the video buffer. For instance, assuming no buffer overflow protection is provided, at another time T+V, the first video packet may be present in the video buffer. Also at time T+V, the separating module 132 may be configured to provide a second video packet to the video buffer. However, the video buffer may not be large enough to store both the first video packet and the second video packet, thereby causing a buffer overflow.

Therefore, in order to prevent a buffer overflow, the video encoding module 112 may be configured to adjust a buffer size associated with the video buffer and a compression rate associated with the video packets. For example, during an initial communication establishment between the video encoding module 112 and the video decoding module 136, the video decoding module may communicate the actual buffer size of the video buffer to the video encoding module 112. However, in order to prevent buffer overflow in the video buffer, the video encoding module 112 may assume an adjusted buffer size of the video buffer, which may be smaller than the actual size of the video buffer. In certain implementations, the video encoding module 112 may assume an adjusted buffer size equal to the difference between the actual buffer size of the video buffer and the maximum allowed packet size of an audio packet. To this end, the video encoding module 112 may be configured to determine, based at least in part on the adjusted buffer size, a compression rate associated with transmitted video packets (e.g., and therefore the compression rate of the first video packet and the second video packet as well).

Thus, while the video encoder 112 may operate under the assumption that the video buffer is of the adjusted buffer size, the video buffer may in reality still be of the actual buffer size. However, the video encoder 112 may determine the compression rate of the video packets to fit within the adjusted buffer size, thereby providing extra headroom in the video buffer (which is of the larger, actual buffer size). Since the actual buffer size may be greater than the adjusted buffer size by the maximum allowed audio packet size, and the delayed amount of time (e.g., to process the first video packet) may be less than or equal to the time taken to transmit an audio packet of the maximum allowed audio packet size, buffer overflow in the video buffer may be prevented. Continuing with the above example, the compression rate may be determined such that the video buffer can sufficiently store both the first video packet and the second video packet at time T+V. Thus, a buffer overflow of the video buffer may be avoided.

It will be appreciated that the above processes described with reference to preventing buffer underflow and buffer overflow with respect to the video buffer may be equally applied with respect to audio buffer. In such situations, the roles of the audio encoder 112, video encoding module 112, audio decoding module 134, and/or the video decoding module 136 may be reversed. For example, the combining module 114 may determine that a second video packet is to be transmitted in the data stream before a second audio packet. As such, upon receiving the data stream, the separating module 132 in the receiving device 124 may be configured to provide the second video packet to the video decoding module 136 before providing the second audio packet to the audio decoding module 134.

To this end, a delay may be created (e.g., while the second video packet is being transmitted/provided to the video buffer) before the second audio packet can be provided to the audio buffer, which may create a potential buffer underflow in the audio buffer. In order to prevent such a buffer underflow, the audio encoding module 110 may determine an amount of time to delay the audio decoding module's 134 access to the audio buffer and/or decoding of the second audio packet. In certain embodiments, the amount of time delayed may be based at least in part on a packet size and/or a compression rate associated with the second video packet. For example, under the STD standard, a maximum allowed packet size and a standard bit rate may be associated with all video packets. To this end, audio encoding module 110 may be configured to determine the delayed amount of time to be approximately equal to the maximum allowed packet size of video packets divided by the standard bit rate of video packets (e.g., the amount of time used to transmit a video packet of the maximum allowed video packet size). Furthermore, the audio encoding module 110 may add the delayed amount of time to the presentation time value associated with second audio packet (e.g., and/or all subsequently transmitted audio packets). Thus, the audio decoding module's 134 decoding of the second audio packet may be performed at the new presentation time value (e.g., the original presentation time value plus the delayed amount of time), and buffer underflow may be avoided. Regardless of the basis for its determination, the amount of time delayed may be determined such that the second audio packet is present in the audio buffer when the audio decoding module 134 attempts to access the audio buffer.

Again, as a result of delaying the audio encoding module's 134 access of the audio buffer and/or decoding of the second audio packet, a buffer overflow may potentially occur in the audio buffer. Therefore, in order to prevent a buffer overflow, the audio encoding module 110 may be configured to adjust a buffer size associated with the audio buffer and a compression rate associated with the audio packets. For example, during an initial communication establishment between the audio encoding module 110 and the audio decoding module 134, the audio decoding module 134 may communicate the actual buffer size of the audio buffer to the audio encoding module 110. However, in order to prevent buffer overflow in the audio buffer, the audio encoding module 110 may determine/assume an adjusted buffer size of the audio buffer, which may be smaller than the actual size of the audio buffer.

In certain implementations, the audio encoding module 110 may assume an adjusted buffer size equal to the difference between the actual buffer size of the audio buffer and the maximum allowed packet size of a video packet. To this end, the audio encoding module 110 may be configured to determine, based at least in part on the adjusted buffer size, a compression rate associated with the transmission of audio packets. Since the actual buffer size may be greater than the adjusted buffer size by the maximum allowed video packet size, and the delayed amount of time (e.g., to process the second audio packet) may be less than or equal to the time taken to transmit a video packet of the maximum allowed video packet size, buffer overflow in the audio may be prevented.

Therefore, in order to prevent a buffer overflow, the audio decoding module 134 may transmit a reported audio buffer size, associated with the audio buffer, to the audio encoding module 110. The reported audio buffer size may be less than the actual buffer size of the audio buffer. In some implementations, the reported audio buffer size may be equal to the difference between the actual buffer size and a maximum video packet size associated with the second video packet. To this end, the audio encoding module 110 may be configured to adjust a compression rate associated with audio packets encoded subsequently to the second audio packet. For example, the video encoding module 112 may adjust a compression rate associated with a third audio packet (e.g., thereby reducing its packet size) such that the audio buffer can sufficiently store both the second audio packet and the third audio packet at a particular point in time. Thus, a buffer overflow of the video buffer may be avoided.

According to one or more embodiments, decoded audio packets and video packets may be provided to a media playback application (not pictured). The media playback application may be configured to process the audio packets and the video packets for playback (e.g., rendering video data on the display 142 and/or outputting audio data via one or more network and I/O devices 140, such as playing movies, music, and/or other media).

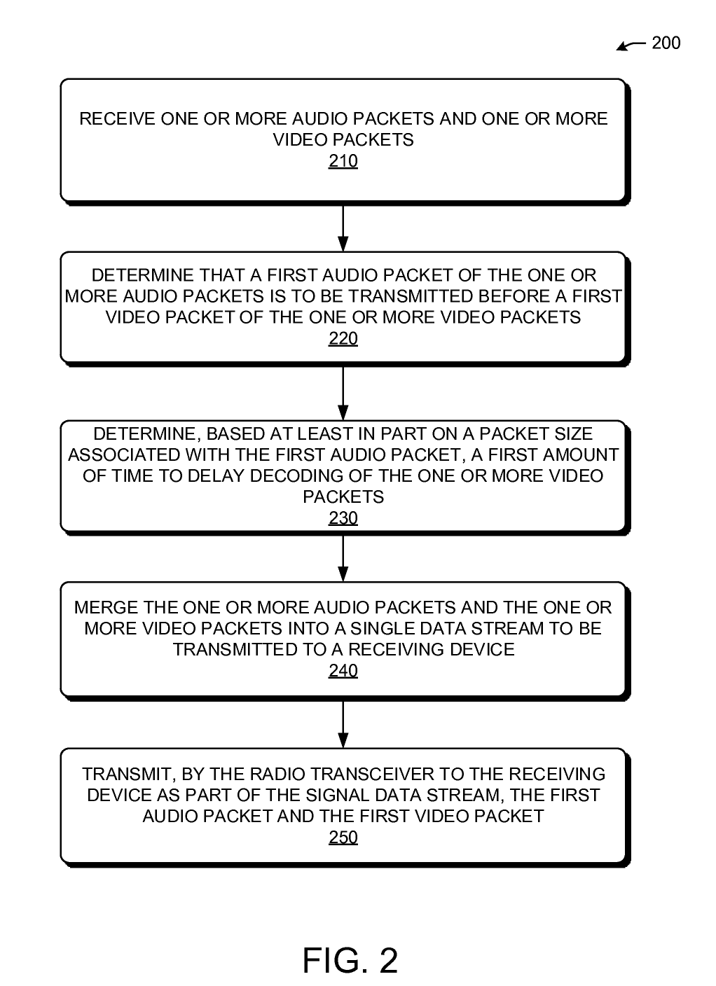

Referring now to FIG. 2, a flow diagram of a method 200 is illustrated for transmitting audio data and video data in accordance with one or more example embodiments. The method 200 may begin in block 210 where a transmitting device 102 may receive, product, generate, and/or otherwise provide for one or more audio packets and one or more video packets. In block 220, the transmitting device 102 (e.g., the combining module 114) may determine that a first audio packet is to be transmitted (e.g., to the audio decoding module 134) before a first video packet is transmitted (e.g., to the video decoding module 136). In block 230, the transmitting device 102 (e.g., the video encoding module 112) may determine, based at least in part on a packet size associated with the first audio packet, a first amount of time to delay decoding of the one or more video packets (e.g., the first video packet). In certain implementations, the packet size may be a maximum audio packet size that is allowed (e.g., according to the STD standard) for the one or more audio packets. In block 240, the transmitting device 102 (e.g., the combining module 114) may merge the one or more audio packets and the one or more video packets into a single data stream to be transmitted to the receiving device 124. In block 250, the transmitting device 102 may transmit, to the receiving device 124 as part of the single data stream, the first audio packet and the first video packet. The first audio packet may be transmitted before the first video packet.

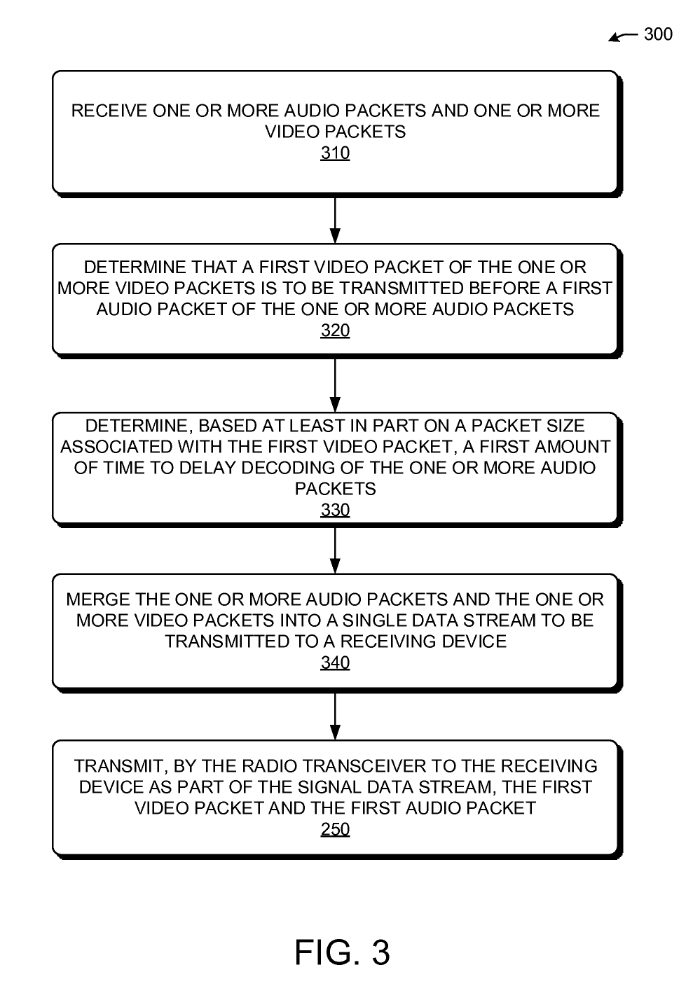

Referring now to FIG. 3, a flow diagram of a method 300 is illustrated for transmitting audio data and video data in accordance with one or more example embodiments. The method 300 may begin in block 310 where a transmitting device 102 may receive, product, generate, and/or otherwise provide for one or more audio packets and one or more video packets. In block 320, the transmitting device 102 (e.g., the combining module 114) may determine that a first video packet is to be transmitted (e.g., to the video decoding module 136) before a first audio packet is transmitted (e.g., to the audio decoding module 134). In block 330, the transmitting device 102 (e.g., the audio encoding module 110) may determine, based at least in part on a packet size associated with the first video packet, a first amount of time to delay decoding of the one or more audio packets (e.g., the first audio packet). In certain implementations, the packet size may be a maximum video packet size that is allowed (e.g., according to the STD standard) for the one or more video packets. In block 340, the transmitting device 102 (e.g., the combining module 114) may merge the one or more audio packets and the one or more video packets into a single data stream to be transmitted to the receiving device 124. In block 350, the transmitting device 102 may transmit, to the receiving device 124 as part of the single data stream, the first audio packet and the first video packet. The first video packet may be transmitted before the first audio packet.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Examples

Example 1 is a device for wireless communication, comprising: a radio transceiver; at least one processor; and an encoder in communication with the radio transceiver and the at least one processor, the encoder configured to: receive one or more audio packets and one or more video packets; determine that a first audio packet of the one or more audio packets is to be transmitted before a first video packet of the one or more video packets; determine, based at least in part on a packet size associated with the first audio packet, a first amount of time to delay decoding of the one or more video packets; merge the one or more audio packets and the one or more video packets into a single data stream to be transmitted to a receiving device; and transmit, by the radio transceiver to the receiving device as part of the single data stream, the first audio packet and the first video packet, wherein the first audio packet is transmitted before the first video packet.

In Example 2, the subject matter of Example 1 can optionally include that configuring the encoder to determine that the first audio packet is to be transmitted before the first video packet further comprises configuring the encoder to: determine that a clock value associated with the first audio packet is less than the clock value associated with the first video packet.

In Example 3, the subject matter of Example 1 can optionally include that the packet size associated with the first audio packet is a maximum audio packet size associated with the one or more audio packets.

In Example 4, the subject matter of Example 1 can optionally include that the encoder is further configured to: add, before transmission of the first video packet, the first amount of time to a presentation time value associated with first video packet.

In Example 5, the subject matter of Example 1 can optionally include that the encoder is further configured to: receive, from the receiving device, an actual video buffer size associated with a video buffer; and determine, based at least in part on the packet size associated with the first audio packet and the actual video buffer size, an adjusted video buffer size associated with the video buffer.

In Example 6, the subject matter of Example 5 can optionally include that the adjusted video buffer size is equal to a difference between the actual video buffer size and a maximum audio packet size associated with the one or more audio packets.

In Example 7, the subject matter of Example 5 can optionally include that the encoder is further configured to: determine, based at least in part on the adjusted video buffer size, a compression rate associated with the one or more video packets.

In Example 8, the subject matter of Example 1 can optionally include that the encoder is further configured to: determine that a second video packet of the one or more video packets is to be transmitted before a second audio packet of the one or more audio packets; determine, based at least in part on a packet size associated with the second video packet, a second amount of time to delay decoding of the one or more audio packets; and transmit, by the radio transceiver to the receiving device as part of the single data stream, the second video packet and the second audio packet, wherein the second video packet is transmitted before the second audio packet.

In Example 9, the subject matter of Example 8 can optionally include that configuring the encoder to determine that the second video packet is to be transmitted before the second audio packet further comprises configuring the encoder to: determine that a clock value associated with the second video packet is less than the clock value associated with the second audio packet.

In Example 10, the subject matter of Example 8 can optionally include that the packet size associated with the second video packet is a maximum video packet size associated with the one or more video packets.

In Example 11, the subject matter of Example 8 can optionally include that the encoder is further configured to: receive, from the receiving device, an actual audio buffer size associated with an audio buffer; and determine, based at least in part on the packet size associated with the second video packet and the actual audio buffer size, an adjusted audio buffer size associated with the audio buffer.

In Example 12, the subject matter of Example 11 can optionally include that the adjusted audio buffer size is equal to a difference between the actual audio buffer size and a maximum video packet size associated with the one or more video packets.

In Example 13, the subject matter of Example 11 can optionally include that the encoder is further configured to: determine, based at least in part on the adjusted audio buffer size, a compression rate associated with the one or more audio packets.

Example 14 is a method for wireless communication, comprising: receiving, by a computer comprising one or more processors, one or more audio packets and one or more video packets; determining that a first audio packet of the one or more audio packets is to be transmitted before a first video packet of the one or more video packets; determining, based at least in part on a packet size associated with the first audio packet, a first amount of time to delay decoding of the one or more video packets; merging the one or more audio packets and the one or more video packets into a single data stream to be transmitted to a receiving device; and transmitting, to the receiving device as part of the single data stream, the first audio packet and the first video packet, wherein the first audio packet is transmitted before the first video packet.

In Example 15, the subject matter of Example 14 can optionally include that the packet size associated with the first audio packet is a maximum audio packet size associated with the one or more audio packets.

In Example 16, the subject matter of Example 14 can optionally include adding, before transmission of the first video packet, the first amount of time to a presentation time value associated with first video packet.

In Example 17, the subject matter of Example 14 can optionally include receiving, from the receiving device, an actual video buffer size associated with a video buffer; and determining, based at least in part on the packet size associated with the first audio packet and the actual video buffer size, an adjusted video buffer size associated with the video buffer.

In Example 18, the subject matter of Example 17 can optionally include that the adjusted video buffer size is equal to a difference between the actual video buffer size and a maximum audio packet size associated with the one or more audio packets.

In Example 19, the subject matter of Example 17 can optionally include determining, based at least in part on the adjusted video buffer size, a compression rate associated with the one or more video packets.

In Example 20, the subject matter of Example 14 can optionally include determining that a second video packet of the one or more video packets is to be transmitted before a second audio packet of the one or more audio packets; determining, based at least in part on a packet size associated with the second video packet, a second amount of time to delay decoding of the one or more audio packets; and transmitting, by the radio transceiver to the receiving device as part of the single data stream, the second video packet and the second audio packet, wherein the second video packet is transmitted before the second audio packet.

Example 21 is a non-transitory computer readable medium comprising computer-executable instructions, that when executed by at least one processor, causes the at least one processor to: receive one or more audio packets and one or more video packets; determine that a first audio packet of the one or more audio packets is to be transmitted before a first video packet of the one or more video packets; determine, based at least in part on a packet size associated with the first audio packet, a first amount of time to delay decoding of the one or more video packets; merge the one or more audio packets and the one or more video packets into a single data stream to be transmitted to a receiving device; and transmit, by the radio transceiver to the receiving device as part of the single data stream, the first audio packet and the first video packet, wherein the first audio packet is transmitted before the first video packet.

In Example 22, the subject matter of Example 21 can optionally include that the computer-executable instructions to determine that the first audio packet is to be transmitted before the first video packet further comprises computer-executable instructions to: determine that a clock value associated with the first audio packet is less than the clock value associated with the first video packet.

In Example 23, the subject matter of Example 21 can optionally include that the packet size associated with the first audio packet is a maximum audio packet size associated with the one or more audio packets.

In Example 24, the subject matter of Example 21 can optionally include computer-executable instructions to: add, before transmission of the first video packet, the first amount of time to a presentation time value associated with first video packet.

In Example 25, the subject matter of Example 21 can optionally include computer-executable instructions to: receive, from the receiving device, an actual video buffer size associated with a video buffer; and determine, based at least in part on the packet size associated with the first audio packet and the actual video buffer size, an adjusted video buffer size associated with the video buffer.

In Example 26, the subject matter of Example 25 can optionally include that the adjusted video buffer size is equal to a difference between the actual video buffer size and a maximum audio packet size associated with the one or more audio packets.

In Example 27, the subject matter of Example 25 can optionally include computer-executable instructions to: determine, based at least in part on the adjusted video buffer size, a compression rate associated with the one or more video packets.

In Example 28, the subject matter of Example 21 can optionally include computer-executable instructions to: determine that a second video packet of the one or more video packets is to be transmitted before a second audio packet of the one or more audio packets; determine, based at least in part on a packet size associated with the second video packet, a second amount of time to delay decoding of the one or more audio packets; and transmit, to the receiving device as part of the single data stream, the second video packet and the second audio packet, wherein the second video packet is transmitted before the second audio packet.

In Example 29, the subject matter of Example 28 can optionally include that the computer-executable instructions to determine that the second video packet is to be transmitted before the second audio packet further comprises computer-executable instructions to: determine that a clock value associated with the second video packet is less than the clock value associated with the second audio packet.

In Example 30, the subject matter of Example 28 can optionally include that the packet size associated with the second video packet is a maximum video packet size associated with the one or more video packets.

In Example 31, the subject matter of Example 28 can optionally include computer-executable instructions to: receive, from the receiving device, an actual audio buffer size associated with an audio buffer; and determine, based at least in part on the packet size associated with the second video packet and the actual audio buffer size, an adjusted audio buffer size associated with the audio buffer.

In Example 32, the subject matter of Example 31 can optionally include that the adjusted audio buffer size is equal to a difference between the actual audio buffer size and a maximum video packet size associated with the one or more video packets.

In Example 33, the subject matter of Example 31 can optionally include computer-executable instructions to: determine, based at least in part on the adjusted audio buffer size, a compression rate associated with the one or more audio packets.

Example 34 is an apparatus for wireless communication, comprising: means for receiving one or more audio packets and one or more video packets; means for determining that a first audio packet of the one or more audio packets is to be transmitted before a first video packet of the one or more video packets; means for determining based at least in part on a packet size associated with the first audio packet, a first amount of time to delay decoding of the one or more video packets; means for merging the one or more audio packets and the one or more video packets into a single data stream to be transmitted to a receiving device; and means for transmitting, by the radio transceiver to the receiving device as part of the single data stream, the first audio packet and the first video packet, wherein the first audio packet is transmitted before the first video packet.

In Example 35, the subject matter of Example 34 can optionally include that the means for determining that the first audio packet is to be transmitted before the first video packet further comprises: means for determining that a clock value associated with the first audio packet is less than the clock value associated with the first video packet

In Example 36, the subject matter of Example 34 can optionally include that the packet size associated with the first audio packet is a maximum audio packet size associated with the one or more audio packets.

In Example 37, the subject matter of Example 34 can optionally include means for adding, before transmission of the first video packet, the first amount of time to a presentation time value associated with first video packet.

In Example 38, the subject matter of Example 34 can optionally include means for receiving, from the receiving device, an actual video buffer size associated with a video buffer; and means for determining, based at least in part on the packet size associated with the first audio packet and the actual video buffer size, an adjusted video buffer size associated with the video buffer.

In Example 39, the subject matter of Example 38 can optionally include that the adjusted video buffer size is equal to a difference between the actual video buffer size and a maximum audio packet size associated with the one or more audio packets.

In Example 40, the subject matter of Example 38 can optionally include means for determining, based at least in part on the adjusted video buffer size, a compression rate associated with the one or more video packets.

In Example 41, the subject matter of Example 34 can optionally include means for determining that a second video packet of the one or more video packets is to be transmitted before a second audio packet of the one or more audio packets; means for determining, based at least in part on a packet size associated with the second video packet, a second amount of time to delay decoding of the one or more audio packets; and means for transmitting, to the receiving device as part of the single data stream, the second video packet and the second audio packet, wherein the second video packet is transmitted before the second audio packet.

In Example 42, the subject matter of Example 41 can optionally include that the means for determining that the second video packet is to be transmitted before the second audio packet further comprises: means for determining that a clock value associated with the second video packet is less than the clock value associated with the second audio packet.

In Example 43, the subject matter of Example 41 can optionally include that the packet size associated with the second video packet is a maximum video packet size associated with the one or more video packets.

In Example 44, the subject matter of Example 41 can optionally include means for receiving, from the receiving device, an actual audio buffer size associated with an audio buffer; and means for determining, based at least in part on the packet size associated with the second video packet and the actual audio buffer size, an adjusted audio buffer size associated with the audio buffer.

In Example 45, the subject matter of Example 44 can optionally include that the adjusted audio buffer size is equal to a difference between the actual audio buffer size and a maximum video packet size associated with the one or more video packets.

In Example 46, the subject matter of Example 44 can optionally include means for determining, based at least in part on the adjusted audio buffer size, a compression rate associated with the one or more audio packets.

What is claimed is:

1. A device for wireless communication, comprising:
a radio transceiver;
at least one processor; and
an encoder in communication with the radio transceiver and the at least one processor, the encoder configured to:
receive one or more audio packets and one or more video packets;
determine that a first audio packet of the one or more audio packets is to be transmitted before a first video packet of the one or more video packets;
determine, based at least in part on a packet size associated with the first audio packet, a first amount of time to delay decoding of the one or more video packets;
merge the one or more audio packets and the one or more video packets into a single data stream to be transmitted to a receiving device; and
transmit, by the radio transceiver to the receiving device as part of the single data stream, the first audio packet and the first video packet, wherein the first audio packet is transmitted before the first video packet.

2. The device of claim 1, wherein configuring the encoder to determine that the first audio packet is to be transmitted before the first video packet further comprises configuring the encoder to:
determine that a clock value associated with the first audio packet is less than the clock value associated with the first video packet.

3. The device of claim 1, wherein the packet size associated with the first audio packet is a maximum audio packet size associated with the one or more audio packets.

4. The device of claim 1, wherein the encoder is further configured to:
add, before transmission of the first video packet, the first amount of time to a presentation time value associated with first video packet.

5. The device of claim 1, wherein the encoder is further configured to:
receive, from the receiving device, an actual video buffer size associated with a video buffer; and
determine, based at least in part on the packet size associated with the first audio packet and the actual video buffer size, an adjusted video buffer size associated with the video buffer.

6. The device of claim 5, wherein the adjusted video buffer size is equal to a difference between the actual video buffer size and a maximum audio packet size associated with the one or more audio packets.

7. The device of claim 5, wherein the encoder is further configured to:
determine, based at least in part on the adjusted video buffer size, a compression rate associated with the one or more video packets.

8. The device of claim 1, wherein the encoder is further configured to:
determine that a second video packet of the one or more video packets is to be transmitted before a second audio packet of the one or more audio packets;
determine, based at least in part on a packet size associated with the second video packet, a second amount of time to delay decoding of the one or more audio packets; and
transmit, by the radio transceiver to the receiving device as part of the single data stream, the second video packet and the second audio packet, wherein the second video packet is transmitted before the second audio packet.

9. The device of claim 8, wherein configuring the encoder to determine that the second video packet is to be transmitted before the second audio packet further comprises configuring the encoder to:
determine that a clock value associated with the second video packet is less than the clock value associated with the second audio packet.

10. The device of claim 8, wherein the packet size associated with the second video packet is a maximum video packet size associated with the one or more video packets.

11. The device of claim 8, wherein the encoder is further configured to:
receive, from the receiving device, an actual audio buffer size associated with an audio buffer; and
determine, based at least in part on the packet size associated with the second video packet and the actual audio buffer size, an adjusted audio buffer size associated with the audio buffer.

12. The device of claim 11, wherein the adjusted audio buffer size is equal to a difference between the actual audio buffer size and a maximum video packet size associated with the one or more video packets.

13. The device of claim 11, wherein the encoder is further configured to:
determine, based at least in part on the adjusted audio buffer size, a compression rate associated with the one or more audio packets.

14. A method for wireless communication, comprising:
receiving, by a computer comprising one or more processors, one or more audio packets and one or more video packets;
determining that a first audio packet of the one or more audio packets is to be transmitted before a first video packet of the one or more video packets;
determining, based at least in part on a packet size associated with the first audio packet, a first amount of time to delay decoding of the one or more video packets;
merging the one or more audio packets and the one or more video packets into a single data stream to be transmitted to a receiving device; and
transmitting, to the receiving device as part of the single data stream, the first audio packet and the first video packet, wherein the first audio packet is transmitted before the first video packet.

15. The method of claim 14, wherein the packet size associated with the first audio packet is a maximum audio packet size associated with the one or more audio packets.

16. The method of claim 14, further comprising:
adding, before transmission of the first video packet, the first amount of time to a presentation time value associated with first video packet

17. The method of claim 14, further comprising:
receiving, from the receiving device, an actual video buffer size associated with a video buffer; and
determining, based at least in part on the packet size associated with the first audio packet and the actual video buffer size, an adjusted video buffer size associated with the video buffer.

18. The method of claim 17, wherein the adjusted video buffer size is equal to a difference between the actual video buffer size and a maximum audio packet size associated with the one or more audio packets.

19. The method of claim 17, further comprising:
determining, based at least in part on the adjusted video buffer size, a compression rate associated with the one or more video packets

20. The method of claim 14, further comprising:
determining that a second video packet of the one or more video packets is to be transmitted before a second audio packet of the one or more audio packets;
determining, based at least in part on a packet size associated with the second video packet, a second amount of time to delay decoding of the one or more audio packets; and
transmitting, by the radio transceiver to the receiving device as part of the single data stream, the second video packet and the second audio packet, wherein the second video packet is transmitted before the second audio packet.

21. A non-transitory computer readable medium comprising computer-executable instructions, that when executed by at least one processor, causes the at least one processor to:
receive one or more audio packets and one or more video packets;
determine that a first audio packet of the one or more audio packets is to be transmitted before a first video packet of the one or more video packets;
determine, based at least in part on a packet size associated with the first audio packet, a first amount of time to delay decoding of the one or more video packets;
merge the one or more audio packets and the one or more video packets into a single data stream to be transmitted to a receiving device; and
transmit, by the radio transceiver to the receiving device as part of the single data stream, the first audio packet and the first video packet, wherein the first audio packet is transmitted before the first video packet.
